(19) United States
(12) Patent Application Publication
(10) Pub. No.: US 2013/0101349 A1
(43) Pub. Date: Apr. 25, 2013

(54) GEOGRID REINFORCED COMPACTABLE ASPHALTIC CONCRETE COMPOSITE, AND METHOD OF FORMING THE COMPOSITE

(71) Applicant: TENSAR INTERNATIONAL, Alpharetta, GA (US)

(72) Inventors: Mark H. WAYNE, Dunwoody, GA (US); Jayhyun KWON, Alpharetta, GA (US)

(73) Assignee: TENSAR INTERNATIONAL, Alpharetta, GA (US)

(21) Appl. No.: 13/651,720

(22) Filed: Oct. 15, 2012

Related U.S. Application Data
(60) Provisional application No. 61/627,571, filed on Oct. 14, 2011.

(51) Int. Cl. E01C 11/18; B32B 3/26

(52) U.S. Cl. CPC E01C 11/18; B32B 3/266
USPC 404/31; 404/75; 428/134

(57) ABSTRACT

A geogrid reinforced compactable asphaltic concrete composite includes a bottom layer, a first compacted layer of asphaltic concrete, a triaxial geogrid, and a second compacted layer of asphaltic concrete. The first layer and the second layer each include an aggregate having sharp, compound edges, which when mixed in asphaltic cement, create an aggregate interlock within the triaxial geogrid that provides strength to a paved surface. As a result of the triangular aperture geometry of the triaxial geogrid, the geogrid provides an asphalt lateral confinement zone within the composite. The zone allows for the formation of transverse hairline cracks as stresses on the composite necessitate. At elevated temperatures, the asphaltic cement softens and flows into the small transverse cracks, thus enabling the asphalt mats to substantially reseal themselves.

### CROSS-REFERENCE TO RELATED APPLICATION

This application claims the benefit of priority to U.S. Provisional Application for Patent No. 61/627,571 filed Oct. 14, 2011.

### BACKGROUND OF THE INVENTION

1. Field of the Invention

The present invention generally relates to a compactable asphaltic concrete such as that used for a highway pavement. More specifically, the present invention relates to a geogrid reinforced compactable asphaltic concrete composite, and a method of forming the composite.

2. Description of the Prior Art

As described in U.S. Pat. No. 5,494,373, a conventional process of laying a continuous longitudinally extending surface of asphalt mat, such as that on a highway or road, is known. In general, a liquid asphaltic cement is heated to a temperature of approximately 250°-300° F. and is mixed with an aggregate. The mixture is then spread evenly on a smooth sub-base and is compressed or compacted to provide a traveling surface that, when cooled to ambient temperatures, is initially very flexible and resistant to wear.

However, over time and with the change in seasons, the asphalt mat is exposed to a wide range of changing temperatures. As the temperature decreases, the asphalt mat contracts, causing random generally transverse cracking. When the temperature subsequently increases, the asphalt mat then expands. However, the mat expands randomly, and in doing so, does not return to its original size. Thus, when the mat expands there is less material to cover the same area of sub-base. In addition, the cracks that developed during the period of decreased temperature remain.

Though the temperature-induced cracks appear randomly, empirical evidence suggests that the cracks will occur approximately every 10 to 20 feet and can be as wide as ¼ inch to ¾ inch. Over a period of years, additional cracks will appear at greater frequency (i.e., at closer longitudinal intervals) until some equilibrium is found between the stresses on the mat formed by the temperature changes and traffic, and the flexibility of the mat.

Therefore, a need exists for an asphaltic concrete composite that provides the requisite amount of strength to a paved surface, but that is less susceptible to the cracking that is associated with lateral movement during changes in temperature.

### SUMMARY OF THE INVENTION

The present invention overcomes the above-described limitations of the prior art by providing a triaxial geogrid combined with a specific method of asphaltic concrete placement and compaction to yield a composite that is superior to conventional asphalt. By virtue of the triaxial geogrid's triangular aperture geometry, the geogrid promotes lateral confinement of the aggregate within the asphalt matrix of the composite, thereby limiting the formation of cracks the size of those associated with conventional asphalt, and thus extending pavement life.

According to a preferred embodiment of the present invention, the geogrid reinforced compactable asphaltic concrete composite includes a bottom layer, a first compacted layer of asphaltic concrete that covers the bottom layer, a triaxial geogrid that is installed on the first asphaltic concrete layer, and finally a second compacted layer of asphaltic concrete that covers the geogrid layer. The bottom layer can be unstabilized or stabilized. If the bottom layer is stabilized, the layer can be mechanically stabilized, chemically stabilized, or a combination of being mechanically stabilized and chemically stabilized.

One aspect of the present invention is that the triaxial geogrid is configured to limit lateral expansion of the first and second layers of asphaltic concrete during changes in temperature. The triaxial geogrid includes a plurality of nodes interconnected by molecularly oriented ribs, and a plurality of triangular apertures formed by the interconnected ribs. The triangular apertures provide for interlock of the aggregate component of the asphaltic concrete. By virtue of the above-described construction, the resulting composite includes a sealed “asphalt lateral confinement zone” at a predetermined location in the finished composite.

Another aspect of the present invention is that as environmental stresses on the composite occur, the asphalt lateral confinement zone allows for the formation of cracks to relieve stress, but limits the aforementioned cracks to those of only a relatively small size, i.e., cracks that are essentially transverse hairline cracks. And, advantageously, at elevated temperatures, the asphaltic cement component softens and flows into the aforementioned small cracks, thus enabling the asphaltic concrete layers to substantially reseal themselves.

Another aspect of the present invention is that the method of forming the geogrid reinforced compactable asphaltic concrete composite can employ conventional paving methods. The method includes laying a continuous longitudinally extending uncompressed layer of the compactable asphaltic concrete over the bottom layer to provide the first layer of asphaltic concrete. Then, the triaxial geogrid is placed on the uncompressed first layer of asphaltic concrete. Next, a continuous longitudinally extending uncompressed layer of the compactable asphaltic concrete is laid over the triaxial geogrid to provide the second layer of asphaltic concrete. The first and second layers of compactable asphaltic concrete can be laid manually or by mechanized pavers. Finally, the uncompressed first layer of asphaltic concrete, the triaxial geogrid, and the uncompressed second layer of asphaltic concrete are compacted to provide an asphalt lateral confinement zone within the composite.

In view of the foregoing, it is therefore an object of the present invention to provide a geogrid reinforced compactable asphaltic concrete composite characterized by limited lateral movement of the first and second layers of asphaltic concrete during times of stress on the composite.

Another object of this invention is to provide a composite characterized by stress cracks in the first and second layers of asphaltic concrete that are limited to a relatively small size, i.e., cracks that are essentially transverse hairline cracks.

Still another object of this invention is to provide a composite having first and second layers of asphaltic concrete that are essentially self-sealing at elevated temperature as the asphaltic cement component softens and flows into the aforementioned small transverse cracks.

Yet another object of this invention is to provide a composite that exhibits extended pavement life by virtue of the limited lateral movement, the small crack size, and the self-sealing features of the composite.

Another object of this invention to be specifically enumerated herein is to provide a geogrid reinforced compactable asphaltic concrete composite in accordance with the preceding objects that will conform to conventional forms of processing, be of relatively simple construction and easy to install so as to provide a composite that will be economically feasible, long lasting, durable in service, relatively trouble free in operation, and a general improvement in the art.

These together with other objects and advantages which will become subsequently apparent reside in the details of construction and operation as more fully hereinafter described and claimed, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 is a partial cross-sectional view of a geogrid reinforced compactable asphaltic concrete composite in accordance with a first embodiment of the present invention.

FIG. 2 is a photograph showing a perspective view of a triaxial geogrid component and an aggregate component of the composite illustrated in FIG. 1.

FIG. 3 is a partial cross-sectional view of a geogrid reinforced compactable asphaltic concrete composite in accordance with a second embodiment of the present invention.

FIG. 4 is a partial cross-sectional view of a geogrid reinforced compactable asphaltic concrete composite in accordance with a third embodiment of the present invention.

FIG. 5 is a partial cross-sectional view of a geogrid reinforced compactable asphaltic concrete composite in accordance with a fourth embodiment of the present invention.

FIG. 6 is a photographic side view of the failure during testing of a non-reinforced control beam sample.

FIG. 7 is a graphical representation of beam sample deformation versus loading cycle for comparative testing between non-reinforced control beam samples and triaxial geogrid reinforced beam samples in accordance with the present invention.

### DETAILED DESCRIPTION OF THE PREFERRED EMBODIMENTS

Although preferred embodiments of the invention are explained in detail, it is to be understood that other embodiments are possible. Accordingly, it is not intended that the invention is to be limited in its scope to the details of construction, and arrangement of components set forth in the following description or illustrated in the drawings. The invention is capable of other embodiments and of being practiced or carried out in various ways. Also, in describing the preferred embodiments, specific terminology will be resorted to for the sake of clarity. It is to be understood that each specific term includes all technical equivalents that operate in a similar manner to accomplish a similar purpose. Where possible, components of the drawings that are alike are identified by the same reference numbers.

Referring now specifically to FIG. 1 of the drawings, a geogrid reinforced compactable asphaltic concrete composite in accordance with one embodiment of the present invention is generally designated by reference number 10. The composite 10 includes in general an unstabilized or a stabilized bottom layer, or sub-base, 20, a first compacted layer, or mat, of asphaltic concrete 30 that covers the bottom layer 20, a triaxial geogrid 40 that is installed on the first asphaltic concrete layer 30, and a second compacted layer, or mat, of asphaltic concrete 50 that covers the geogrid 40 layer.

The bottom layer 20 serves as a uniform platform on which to place the first mat of asphaltic concrete 30, the triaxial geogrid 40, and the second mat of asphaltic concrete 50. If the bottom layer 20 is stabilized, the layer can be mechanically stabilized, chemically stabilized, or a combination of being mechanically stabilized and chemically stabilized.

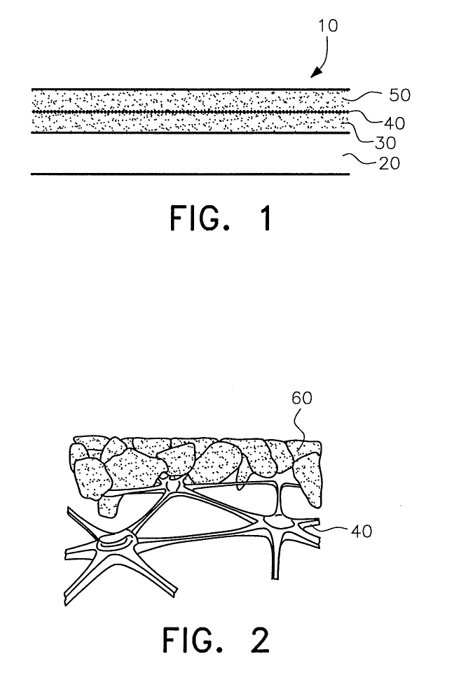

The first mat of asphaltic concrete 30 and the second mat of asphaltic concrete 50 are each an essentially continuous longitudinally extending asphalt mat of compactable asphaltic paving concrete. As shown in FIG. 1, the first mat 30 and the second mat 50 each include, inter alia, an aggregate 60 (see FIG. 2). According to a preferred embodiment of the invention, the aggregate 60 is a mixture of sand, gravel, and stone, with an individual piece of the aggregate 60 having a maximum dimension equal to approximately ¾ inch (19 mm), i.e., a sieve size of approximately ¾ inch. Typically the aggregate 60 is derived from crushed granite, limestone, or gravel, and according to a preferred embodiment, is a mixture of individual pieces having a maximum width size range of from approximately ⅜ inch (9.5 mm) to approximately ¾ inch (19 mm). The aforementioned sources of aggregate, i.e., crushed granite, limestone, or gravel, are preferred because they provide sharp, compound edges, which when mixed in the asphaltic cement, tend to create an aggregate interlock within the triaxial geogrid that provides strength to the paved surface. The general formulation of the asphaltic concrete that is used in the instant composite, including the nature of the asphaltic cement component thereof, and the relative amounts of the aggregate and the asphaltic cement to be combined, are readily available and known to those skilled in the art, and therefore, are not discussed further herein.

An example of the interlock between the aggregate 60 and the triaxial geogrid 40 is shown in FIG. 2. As is evident, even without the asphaltic cement element of mats 30 and 50, the larger and smaller size fractions of the aggregate 60 are, under normal conditions, uniformly distributed in interlocked relation in the composite 10.

The triaxial geogrid 40 is configured to limit lateral expansion of mats 30, 50 during changes in temperature. The triaxial geogrid 40 includes a plurality of nodes interconnected by molecularly oriented ribs, and a plurality of triangular apertures formed by the interconnected ribs. A suitable triaxial geogrid 40 for use in the composite 10 is that described in U.S. Pat. No. 7,001,112 and in U.S. Patent Application Pub. No. 2009/0214821 A1, dated Aug. 27, 2009, both of which are owned by the assignee of the present invention, and the subject matters of both of which are expressly incorporated herein as if they were set forth in their entirety. The triaxial geogrids are commercially available from Tensar International Corporation of Alpharetta, Ga., under the trademark TriAx®. As a result of the triangular aperture geometry, the triaxial geogrid 40 promotes lateral confinement of the aggregate within the asphaltic concrete. In addition, it may be desirable to use a triaxial geogrid with a high aspect ratio rib as disclosed in the aforementioned U.S. Patent Application Pub. No. 2009/0214821 A1.

By virtue of the above-described construction, the resulting geogrid reinforced compactable asphaltic concrete composite 10 includes a sealed “asphalt lateral confinement zone” at a predetermined location in the finished composite. The asphalt lateral confinement zone allows for the formation of transverse hairline cracks as the stresses on the composite necessitate.

Although the mats 30, 50 will undergo substantially the same degree of shrinkage and expansion respectively during the freezing and thawing process as does a conventional asphalt mat, the continuous asphalt lateral confinement will result in an increased number of small, essentially hairline cracks each having a smaller width than those cracks that occur in conventional asphalt mats. That is, the width of a crack occurring in a conventional asphalt mat is typically ¼ inch to ¾ inch, and this accounts for the shrinkage in the length of a mat of approximately 20 to 30 feet.

In contrast, the asphalt mats 30, 50 of the composite 10 will form a series of closely spaced hairline cracks each having a very small width, typically a width of less than approximately ¼ inch. The advantage of the aforementioned smaller cracks of the instant invention relative to the wider cracks associated with a conventional asphalt mat is that the smaller cracks tend to substantially reseal themselves at elevated temperatures. That is, as summer road temperatures reach upwards of 150-180° F., the asphaltic cement element of mats 30, 50 becomes soft and flows into the small fractures to seal them. In addition, the smaller cracks associated with mats 30, 50 allow less moisture, dirt, and debris to penetrate the asphalt, thus avoiding additional maintenance problems.

The present invention also provides a finished asphaltic pavement produced by forming a mat of compactable asphaltic paving concrete on the sub-base surface. The method of forming the geogrid reinforced compactable asphaltic concrete composite is as follows.

A continuous longitudinally extending uncompressed layer of the compactable asphaltic paving concrete is laid over the bottom layer 20 by conventional paving methods to provide mat 30 having a predetermined thickness, as required by the intended use of the composite surface. The particular method of laying the hot asphaltic concrete on the bottom layer 20 to create a smooth compactable asphalt mat may include the use of a conventional mechanical paver, or may simply involve manually shoveling the asphaltic concrete from a container onto the surface of the bottom layer 20 followed by manual smoothing. In any event, the particular methods of spreading and smoothing the compactable asphaltic paving concrete layer on the bottom layer are well known in the art, and accordingly, are not further described herein.

The bottom layer 20 can be unstabilized or stabilized. If the bottom layer 20 is stabilized, the method of forming the geogrid reinforced compactable asphaltic concrete composite includes the additional step of first stabilizing the bottom layer 20. The additional step includes mechanically stabilizing, chemically stabilizing, or a combination of mechanically stabilizing and chemically stabilizing the bottom layer 20.

Once the mat 30 is in place on the bottom layer 20, the triaxial geogrid 40 is placed on the uncompressed mat 30.

Then, a continuous longitudinally extending uncompressed layer of the compactable asphaltic paving concrete 50 is laid over the triaxial geogrid 40 by conventional paving methods to provide mat 50 having a predetermined thickness. This step therefore places the top layer of the “sandwich” of the uncompressed mat 30, the triaxial geogrid 40, and the uncompressed mat 50, thus providing the asphalt lateral confinement zone within the composite 10.

Finally, the uncompressed mat 30, the triaxial geogrid 40, and the uncompressed mat 50 are compacted to seal within the asphalt lateral confinement zone, and provide a finished asphaltic concrete pavement of predetermined density having a smooth traffic bearing surface.

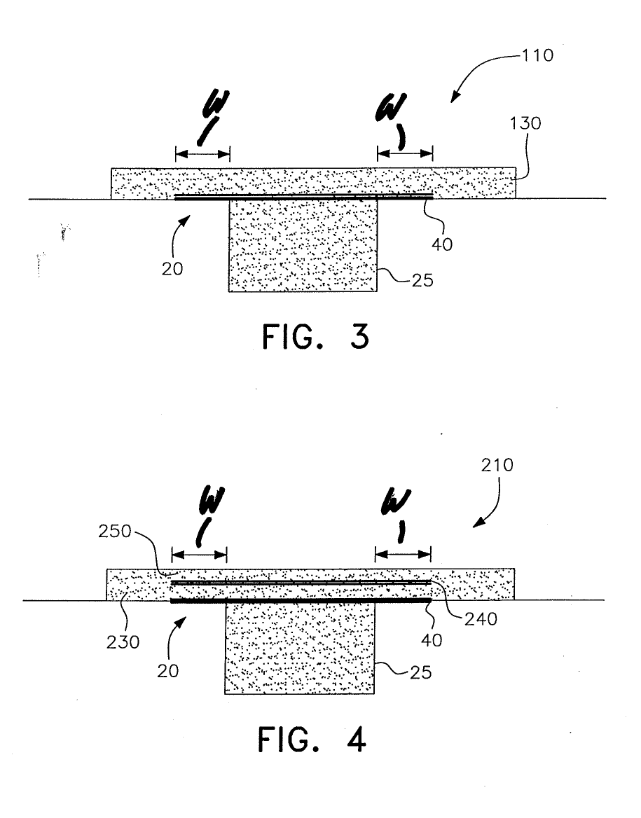

As illustrated in FIGS. 3, 4, and 5, depending upon the particular service of the geogrid reinforced compactable asphaltic concrete composite, other possible embodiments of the composite of this invention are possible.

FIG. 3 shows a composite 110 configured with the triaxial geogrid 40 located, in part, directly on the bottom layer 20 and, in part, directly on a utility cut repair or roadway foundation 25. Composite 110 includes two adjacent layers of asphaltic concrete 130 located directly on top of the triaxial geogrid 40. In a preferred embodiment, the two adjacent layers of asphaltic concrete 130 are configured as a 4 inch deep layer provided in two, 2 inch, lifts or layers. As shown in FIG. 3, a minimum lateral distance “W” between each outer edge of the triaxial geogrid 40 and each outer edge of the utility cut repair or roadway foundation 25 is typically approximately 5 feet.

FIG. 4 shows a composite 210 configured with a first triaxial geogrid 40 located, in part, directly on the bottom layer 20 and, in part, directly on the utility cut repair or roadway foundation 25. Composite 210 includes a first layer of asphaltic concrete 230 located directly on top of the triaxial geogrid 40, a second triaxial geogrid 240 located on the first layer of asphaltic concrete 230, and a second layer of asphaltic concrete 250 located directly on top of the triaxial geogrid 240. In a preferred embodiment, the first layer of asphaltic concrete 230 and the second layer of asphaltic concrete 250 are configured as a 4 inch deep layer provided in two, 2 inch, lifts. As shown in FIG. 4, the minimum lateral distance W between each outer edge of both the first triaxial geogrid 40 and the second triaxial geogrid 240, and each outer edge of the utility cut repair or roadway foundation 25, is typically approximately 5 feet.

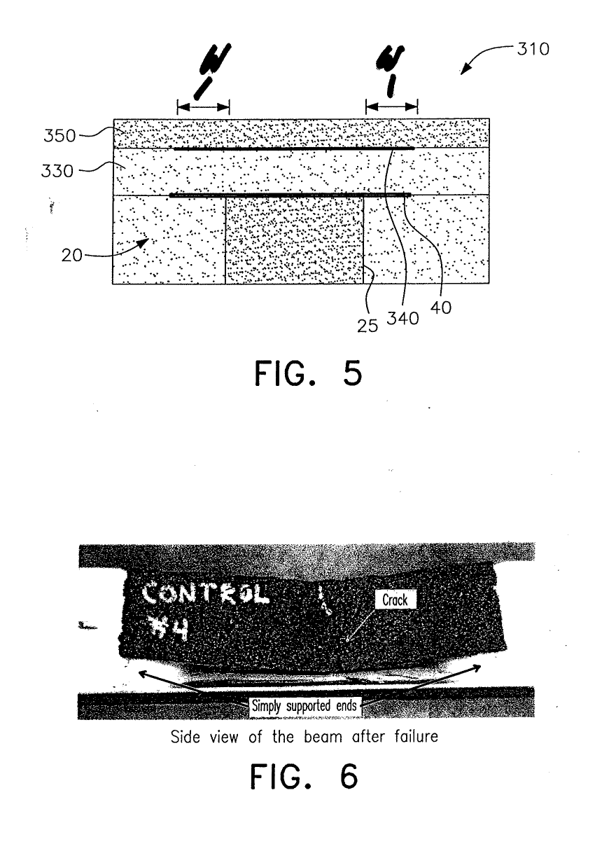

FIG. 5 shows a composite 310 configured with a first triaxial geogrid 40 located, in part, directly on the bottom layer 20 and, in part, directly on the utility cut repair or roadway foundation 25. Composite 310 includes a first, 6 inch deep layer of roadway mix 330 located directly on top of the triaxial geogrid 40. The roadway mix 330 can be, for example, recycled asphalt mixed with existing subgrade material. A second triaxial geogrid 340 is located on the layer of roadway mix 330, and a layer of asphaltic concrete 350 is located directly on top of the triaxial geogrid 340. In a preferred embodiment, the layer of asphaltic concrete 350 is configured as a 4 inch deep layer provided in two, 2 inch, lifts. As shown in FIG. 5, the minimum lateral distance W between each outer edge of both the first triaxial geogrid 40 and the second triaxial geogrid 340, and each outer edge of the utility cut repair or roadway foundation 25, is typically approximately 5 feet.

The geogrid reinforced compactable asphaltic concrete composite in accordance with the present invention was tested to assess its performance relative to non-reinforced samples. Specifically, the composite was tested to assess the fatigue improvement resulting from embedding the triaxial geogrid in the first and second layers of asphaltic concrete.

Beam samples were prepared using an asphalt vibratory compactor commercially available from Pavement Technology, Inc. of Covington, Ga. Samples were prepared both with and without the triaxial geogrid according to the present invention being present in the mid-thickness of the beam. The beam's fatigue life was then determined using an “Asphalt Pavement Analyzer—Jr.,” also commercially available from Pavement Technology, Inc. The Asphalt Pavement Analyzer—Jr. is a multifunctional Loaded Wheel Tester (“LWT”) used for evaluating permanent deformation (rutting), fatigue cracking, and moisture susceptibility of both hot and cold asphalt mixes.

Each sample mass was prepared so as to provide a 300×125×75 mm beam having an estimated 6 percent air voids. Each sample was mixed and aged for two hours at a compaction temperature of 300° F. according to American Association of State Highway and Transportation Officials (“AASHTO”) R30.

Beam fatigue tests on the samples were then performed with the Asphalt Pavement Analyzer—Jr. in constant stress mode with increasing strain. The beam fatigue tests were conducted according to a test method developed by Pavement Technologies, Inc. in draft American Society for Testing and Materials (“ASTM”) format. Each sample was supported at its ends with 265 mm of clear span. A rolling wheel load was applied longitudinally along the length of the beam. A 250 lb vertical load was applied using a steel wheel at the rate of 1 cycle (2 passes, one in each direction) per second. The tests were conducted at a temperature of 68° F. (20° C.)

The deflection of the beam was measured at three locations: 38 mm from each end of the beam, and in the middle. The fatigue failure point is defined as the difference between the deflection at the middle and the ends of the beam equal to or greater than 1-mm in one stroke. Experience indicates samples to have cracked when this 1-mm threshold is exceeded. Two samples can be tested simultaneously.

In each of the tests, a non-reinforced control beam sample was paired with a triaxial geogrid reinforced beam sample according to the instant invention. Each of the triaxial geogrid reinforced beam samples was prepared with the triaxial geogrid placed at the mid-depth of the uncompacted asphalt mixture.

The fatigue performance of the triaxial geogrid reinforced beam samples was compared to that of the non-reinforced control beam samples using a constant stress, increasing deformation (i.e., strain), fatigue test in the Asphalt Pavement Analyzer—Jr. A side view of a control sample beam after failure is shown in FIG. 6.

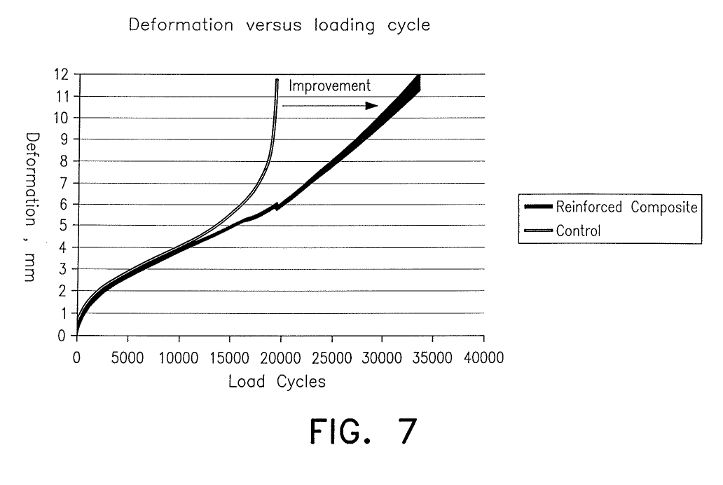

FIG. 7 is a graphical representation of beam sample deformation versus loading cycle for the comparative testing between the non-reinforced control beam samples and the triaxial geogrid reinforced beam samples in accordance with the present invention. As shown in FIG. 7, the results of the above-described testing indicate a significant improvement, i.e., up to an 89% increase in fatigue life, for the triaxial geogrid reinforced beam samples according to the instant invention relative to the non-reinforced control beam samples.

| Treatment | Air Voids % | Cycles to Failure |
|---|---|---|
| Reinforced Composite (TriAx130S) | 6.1 | 35,926 |
| Control | 5.9 | 18,956 |

It is not intended that the present invention be limited to the specific embodiments described herein. The foregoing is considered as illustrative only of the principles of the invention. For example, although the composite 10 has been described as being configured for use in highway pavement applications, the composite could be employed in a different service in which the characteristics and properties of the composite, including the materials of construction, would be beneficial.

Further, since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. A geogrid reinforced compactable asphaltic concrete composite, comprising:
a bottom layer;
a first layer of asphaltic concrete over said bottom layer;
a triaxial geogrid over said first asphaltic concrete layer; and
a second layer of asphaltic concrete over said triaxial geogrid,
said first and second layers of asphaltic concrete being compacted to interlock said triaxial geogrid therebetween.

2. The composite according to claim 1, wherein the first layer and the second layer each include an asphaltic cement and an aggregate having sharp, compound edges.

3. The composite according to claim 1, wherein the aggregate is a mixture of sand, gravel, and stone.

4. The composite according to claim 3, wherein the aggregate is derived from at least one of crushed granite, limestone, or gravel.

5. The composite according to claim 3, wherein an individual piece of the aggregate has a maximum dimension of approximately ¾ inch.

6. The composite according to claim 1, wherein the triaxial geogrid includes a plurality of nodes interconnected by molecularly oriented ribs, and a plurality of triangular apertures formed by the interconnected ribs.

7. The composite according to claim 1, wherein the triaxial geogrid is configured to limit lateral expansion of the first layer and the second layer during changes in temperature.

8. The composite according to claim 1, wherein at lowered temperatures the first layer and the second layer contract and include stress cracks therein having a maximum width of approximately ¼ inch.

9. The composite according to claim 3, wherein the aggregate is a mixture of individual pieces having a maximum width size range of from approximately ⅜ inch to approximately ¾ inch.

10. The composite according to claim 1, wherein the bottom layer is unstabilized or is stabilized.

11. The composite according to claim 10, wherein the stabilized bottom layer is at least one of mechanically stabilized and chemically stabilized.

12. The composite according to claim 1, wherein a utility cut repair or roadway foundation is located laterally adjacent the bottom layer, and wherein the first layer of asphaltic concrete is located over the bottom layer and over the utility cut repair or roadway foundation.

13. A method of forming a geogrid reinforced compactable asphaltic concrete composite that includes a bottom layer, a first layer of asphaltic concrete, a triaxial geogrid, and a second layer of asphaltic concrete, the method comprising:
laying a continuous longitudinally extending uncompressed layer of the compactable asphaltic concrete over the bottom layer to provide the first layer of asphaltic concrete;
placing the triaxial geogrid on the uncompressed first layer of asphaltic concrete;
laying a continuous longitudinally extending uncompressed layer of the compactable asphaltic concrete over the triaxial geogrid to provide the second layer of asphaltic concrete; and
compacting the uncompressed first layer of asphaltic concrete, the triaxial geogrid, and the uncompressed second layer of asphaltic concrete to provide an asphalt lateral confinement zone within the composite.

14. The method according to claim 13, wherein the bottom layer is unstabilized or is stabilized.

15. The method according to claim 13, further comprising a step of stabilizing the bottom layer.

16. The method according to claim 15, wherein the step of stabilizing the bottom layer includes at least one of mechanically stabilizing and chemically stabilizing.

17. The method according to claim 13, wherein a utility cut repair or roadway foundation is located laterally adjacent the bottom layer, and wherein the step of laying the continuous longitudinally extending uncompressed layer of the compactable asphaltic concrete includes laying said layer over the bottom layer and over the utility cut repair or roadway foundation.

18. A geogrid reinforced compactable asphaltic concrete composite, comprising:
a bottom layer;
a first layer of asphaltic concrete over said bottom layer;
a triaxial geogrid over said first asphaltic concrete layer; and
a second layer of asphaltic concrete over said triaxial geogrid,
said triaxial geogrid being configured to improve fatigue resistance of the first and second layers of asphaltic concrete.

19. The composite according to claim 18, wherein the first and second layers of asphaltic concrete are compacted to interlock the triaxial geogrid therebetween so as to limit lateral movement of the first and second layers of asphaltic concrete.

20. The composite according to claim 19, wherein the triaxial geogrid limits the lateral movement such that transverse stress cracks in the first and second layers of asphaltic concrete have a maximum width of approximately ¼ inch.

21. The composite according to claim 20, wherein the first and second layers of asphaltic concrete are substantially self-sealing at elevated temperature as an asphaltic cement therein softens and flows into the transverse stress cracks.
